(19) United States
(12) Patent Application Publication
(10) Pub. No.: US 2005/0011022 A1
(43) Pub. Date: Jan. 20, 2005

(54) Electric toothbrush

(76) Inventor: Mei Chun Kwong, Hong Kong (CN)

Correspondence Address: ALIX YALE & RISTAS LLP, 750 MAIN STREET, SUITE 1400, HARTFORD, CT, 06103, US

(21) Appl. No.: 10/622,036

(22) Filed: Jul. 17, 2003

(51) Int. Cl. A61C 17/22

(52) U.S. Cl. 15/22.1; 15/28

(57) ABSTRACT

A brushing attachment for an electric toothbrush has a neck extending in a longitudinal direction of the brushing attachment, a head at a remote end of the neck, a driveshaft extending in a longitudinal direction of the neck and having a rotation axis extending in the longitudinal direction. There is tuft block mounted to the head for oscillation about a pivot axis extending substantially normally to the rotation axis of the driveshaft. A cam is attached to or formed integrally with the driveshaft and provides a cam surface surrounding the longitudinal axis and being of varied displacement in the longitudinal direction. A cam follower is associated mechanically with the tuft block and bears against the cam surface to effect pivotal oscillation of the tuft block about the pivot axis in use.

### BACKGROUND OF THE INVENTION

The present invention relates to electric toothbrushes. More particularly, although not exclusively, the invention relates to an electric toothbrush head having a tuft block that oscillates about a pivot axis.

Many electric toothbrushes have been proposed with rotating or pivotally oscillating bristle heads. Many of these suffer from complexity of design, cleaning-inefficiency and general inefficiency in operation.

### OBJECTS OF THE INVENTION

It is an object of the present invention to overcome or substantially ameliorate at least one of the above disadvantages and/or more generally to provide an improved electric toothbrush.

### DISCLOSURE OF THE INVENTION

There is disclosed herein a brushing attachment for an electric toothbrush, comprising:
a neck extending in a longitudinal direction of the brushing attachment,
a head at a remote end of the neck,
a driveshaft extending in a longitudinal direction of the neck and having a rotation axis extending in the longitudinal direction,
a tuft block mounted to the head for oscillation about a pivot axis extending substantially normally to the rotation axis of the driveshaft,
a cam attached to or formed integrally with the driveshaft and providing a cam surface surrounding the longitudinal axis and being of varied displacement in the longitudinal direction, and
a cam follower associated mechanically with the tuft block and bearing against the cam surface to effect pivotal oscillation of the tuft block about the pivot axis.

Preferably the head comprises a fixed pin on which the tuft block is mounted.

In one embodiment the cam follower comprises a lever that pivots about an axis that extends across and in a direction substantially normally to the rotation axis of the driveshaft.

In this embodiment there is a connecting rod attached at one end to the cam follower and at its other end to the tuft block that a position offset radially from the tuft block pivot axis.

Preferably one or more seals are provided between the connecting rod and the neck.

In another embodiment the cam extends to the head and interacts directly with the tuft block.

In this embodiment, the cam follower is attached to or formed integrally with the tuft block.

In this embodiment, the cam follower is parallel to and spaced from the pivot axis of the tuft block.

Further, in this embodiment, there might be a seal between the shaft and the neck.

The brushing attachment would typically be attached to or formed integrally with an electric toothbrush.

### BRIEF DESCRIPTION OF THE DRAWINGS

Preferred forms of the present invention will now be described by way of example with reference to the accompanying drawings, wherein:

FIG. 1 is a schematic front elevation in partial cross section of an electric toothbrush having a brushing attachment thereon,

FIG. 2 is a schematic side elevation of the electric toothbrush and brushing attachment of FIG. 1,

FIG. 3 is a schematic cross-sectional elevation of the toothbrush and attachment of FIGS. 1 and 2,

FIG. 4 is a schematic cross-sectional elevation of an alternative brushing attachment with the tuft block in one oscillatory position, and

FIG. 5 is a schematic cross-sectional elevation of the brushing attachment of FIG. 4 with the tuft block in another oscillatory position.

### DESCRIPTION OF THE PREFERRED EMBODIMENTS

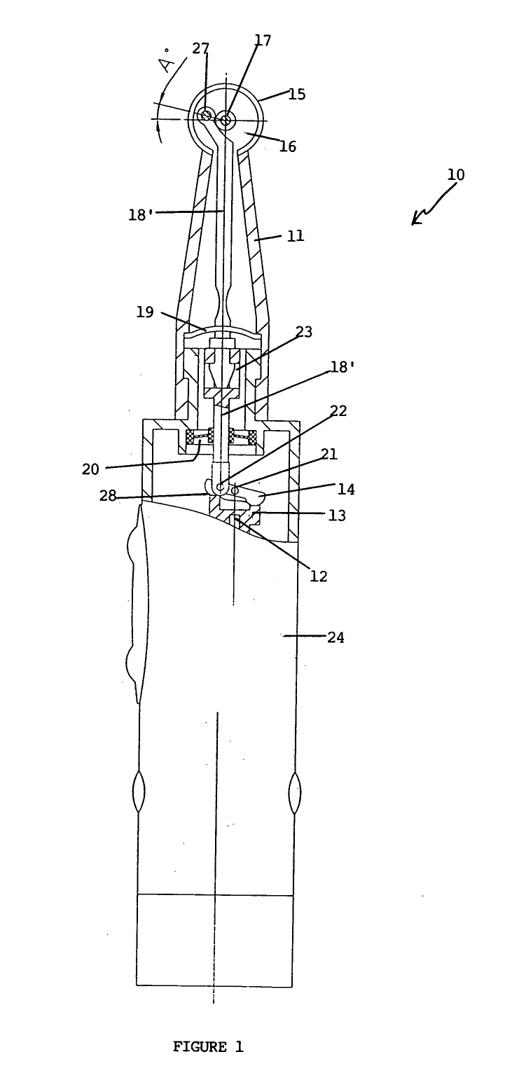

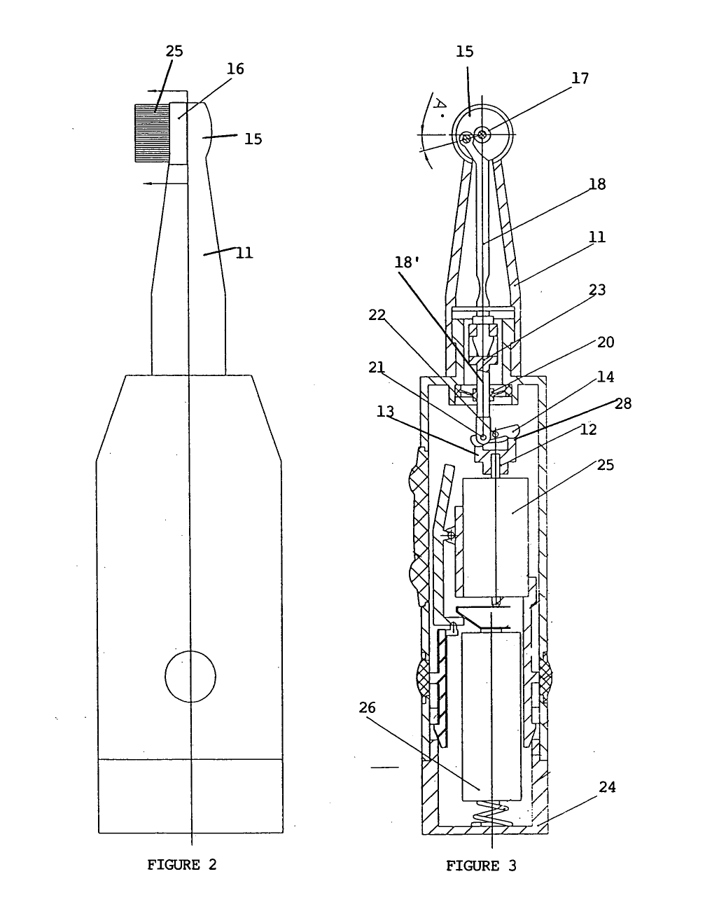

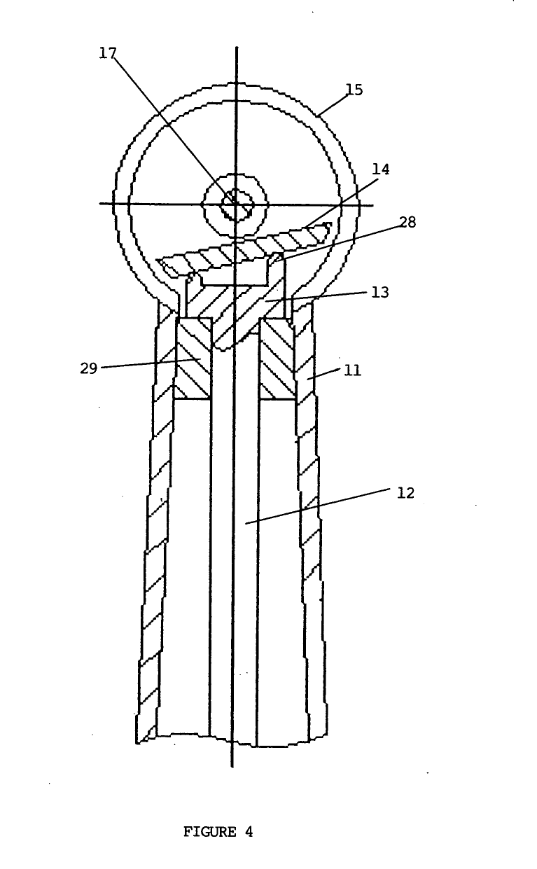

In FIGS. 1 to 3 of the accompanying drawings there is depicted schematically a brushing attachment 10 for an electric toothbrush. The depicted components are typically fabricated as plastics mouldings.

The attachment 10 includes a neck 11 at the remote end of which there is a head 15 inside of which there is mounted a tuft block 16. Bristles 25 extend from the tuft block 16. The tuft block 16 is fitted over a pin 17 that extends internally from the head. The pin 17 defines a pivot axis for the tuft block. The tuft block has an eccentric pin 27 to which the distal end of a connecting rod 18 is fitted. The connecting rod 18 extends in a longitudinal direction through the neck 11. The connecting rod 18 passes through a seal 19 within the head 11.

There is an intermediate connecting rod 18′ connected to the connecting rod 18 at a coupling 23 behind seal 19. There is a further seal 20 between the intermediate connecting rod 18′ and the handle 24 of the toothbrush to which the brushing attachment 11 is attached.

The handle 24 houses an electric motor 25 and a battery 26. Extending from the motor 25 is a driveshaft 12. The rotational axis of the driveshaft 12 is a longitudinal axis of the toothbrush that extends parallel to the connecting rods 18 and 18′.

At the end of the driveshaft 12 remote from the motor 25, there is a cam 13. The cam 13 includes an annular cam surface 28 surrounding the axis of the driveshaft 12. When viewed in end elevation, the cam surface 28 would appear to be circular. The annular cam surface is however oval shaped because it does not extend directly across the axis of the driveshaft 12, but instead extends angularly thereacross.

There is a cam follower lever 14 mounted pivotally to the handle 24 at pivot pin 22. The intermediate connecting rod 18′ is attached pivotally at pin 21 to the lever 14 at a position offset from the pin 22.

As the motor 25 rotates the driveshaft 22, the cam 13 rotates. Interaction between the cam surface 28 and the cam follower lever 14 causes the lever 14 to pivot about pivot pin 22. This in turn causes linear reciprocation of the intermediate connecting rod 18′ and connecting rod 18 via coupling 23. As the connecting rod 18 oscillates in the longitudinal direction, the tuft block 16 oscillates pivotally as indicated by “A” in the figures.

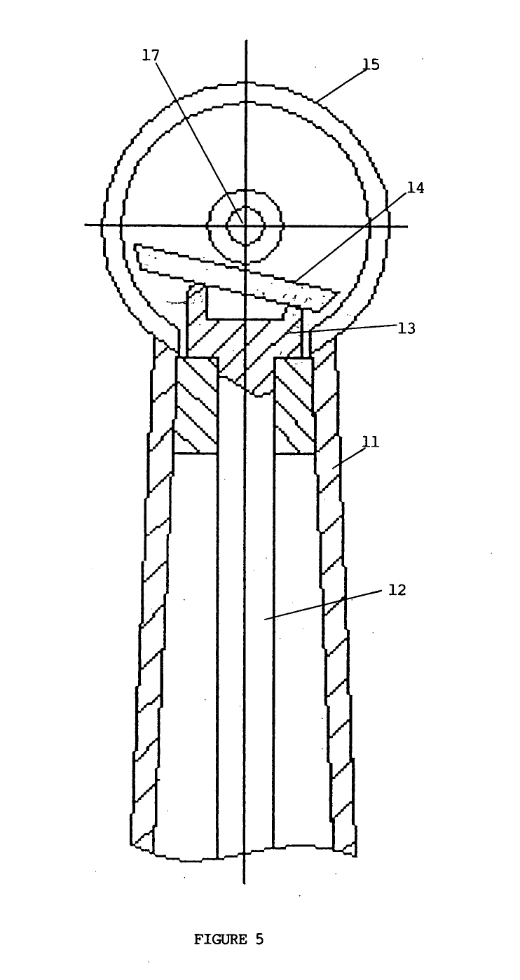

A simplified form of the invention is depicted in the FIGS. 4 and 5. In this embodiment, there is no connecting rod, but instead, the driveshaft 12 extends to a cam 13 at the head 15. The cam follower 14 is in the form of a plate fixed to the tuft block 16 behind the bristles 25. There is a seal or bushing 29 within which the driveshaft 12 rotates. The cam 13 has a cam surface 28 as described earlier but interacting directly with the follower 14. Typically, the follower 14 would be moulded integrally with the tuft block. Rotation of the driveshaft 12 causes the cam surface 28 to interact with the follower 14 in such a way as to in part pivotal oscillation of the tuft block 16 about pin 17.

It should be appreciated that modifications and alterations obvious to those skilled in the art are not to be considered as beyond the scope of the present invention. For example, the driveshaft might be adapted for oscillatory motion, rather than continuously rotation.

1. A brushing attachment for an electric toothbrush, comprising:
a neck extending in a longitudinal direction of the brushing attachment,
a head at a remote end of the neck,
a driveshaft extending in a longitudinal direction of the neck and having a rotation axis extending in the longitudinal direction,
a tuft block mounted to the head for oscillation about a pivot axis extending substantially normally to the rotation axis of the driveshaft,
a cam attached to or formed integrally with the driveshaft and providing a cam surface surrounding the longitudinal axis and being of varied displacement in the longitudinal direction, and
a cam follower associated mechanically with the tuft block and bearing against the cam surface to effect pivotal oscillation of the tuft block about the pivot axis.

2. The brushing attachment of claim 1, wherein the head comprises a fixed pin on which the tuft block is mounted.

3. The brushing attachment of claim 1 wherein the cam follower comprises a lever that pivots about an axis that extends across and in a direction substantially normally to the rotation axis of the driveshaft.

4. The brushing attachment of claim 3 further comprising a connecting rod attached at one end to the cam follower and at its other end to the tuft block that a position offset radially from the tuft block pivot axis.

5. The brushing attachment of claim 4 further comprising one or more seals between the connecting rod and the neck.

6. The brushing attachment of claim 1 wherein the cam extends to the head and interacts directly with the tuft block.

7. The brushing attachment of claim 6 wherein the cam follower is attached to or formed integrally with the tuft block.

8. The brushing attachment of claim 7 wherein the cam follower is parallel to and spaced from the pivot axis of the tuft block.

9. The brushing attachment of claim 7 further comprising a seal between the shaft and the neck.

10. An electric toothbrush having the brushing attachment of any one of the preceding claims attached thereto or formed integrally therewith.
